(19) United States
(12) Patent Application Publication
(10) Pub. No.: US 2026/0024218 A1
(43) Pub. Date: Jan. 22, 2026

(54) SEGMENTING REGIONS OF VIRTUAL MATERIALS

(71) Applicant: Adobe Inc., San Jose, CA (US)

(72) Inventors: Valentin Mathieu Deschaintre, London (BG); Jérémy Nicolas Levallois, Lyon (FR)

(73) Assignee: Adobe Inc., San Jose, CA (US)

(21) Appl. No.: 18/775,994

(22) Filed: Jul. 17, 2024

(51) Int. Cl. G06T 7/40; G06T 7/90

(52) U.S. Cl. CPC G06T 7/40; G06T 7/90; G06T 2200/24; G06T 2207/20104

(57) ABSTRACT

In implementation of techniques for segmenting regions of virtual materials, a computing device implements a material segmentation system to receive a textured mesh representing multiple virtual materials. The material segmentation system also receives an input including a marker identifying one or more regions of the textured mesh corresponding to a material type. Using an algorithm, the material segmentation system generates a material map that segments the material type from other material types of the multiple virtual materials by identifying an additional region of the textured mesh corresponding to the material type by comparing three-dimensional positions of pixels of the textured mesh and categorizing pixels of the one or more regions of the textured mesh together with pixels of the additional region of the textured mesh. The material segmentation system then presents the material map in a user interface.

### BACKGROUND

In computer graphics, a textured mesh is a virtual representation of an object in a three-dimensional space. The object, for instance is computer-generated or is reconstructed based on a counterpart of the object in the real world. Surfaces of the object are formed by vertices, edges, and faces of connected polygons or other points that are defined by locations in the three-dimensional space. The textured mesh includes one or more textures, which are represented by normal properties of the surfaces of the object. Textured meshes are used in a variety of applications in virtual environments, including video game production, product design, advertising, and animation. However, attempts to edit the textured meshes result in visual inaccuracies, computational inefficiencies, and increased power consumption in real world scenarios.

### SUMMARY

Techniques and systems for segmenting regions of virtual materials are described. In an example, a material segmentation system receives a textured mesh representing multiple virtual materials. The material segmentation system also receives an input including a marker identifying one or more regions of the textured mesh corresponding to a material type. In some examples, the marker is a scribble drawn over the textured mesh in the user interface.

The material segmentation system generates a material map that segments the material type from other material types of the multiple virtual materials by identifying an additional region of the textured mesh corresponding to the material type using an algorithm by comparing three-dimensional positions of pixels of the textured mesh and categorizing pixels of the one or more regions of the textured mesh together with pixels of the additional region of the textured mesh. For example, the algorithm is a k-nearest neighbors matting algorithm that considers three-dimensional features of the textured mesh. Some examples further comprise identifying the additional region of the textured mesh by comparing color values and normal properties of the pixels of the textured mesh using the algorithm. Additionally, some examples further comprise receiving an additional input to change a relative importance of the three-dimensional positions, the color values, and the normal properties of the pixels of the textured mesh and updating the algorithm based on the additional input.

The material segmentation system then presents the material map in a user interface. For example, the material map visually designates different material types of the multiple virtual materials. In some examples, the material map includes texture IDs corresponding to the multiple virtual materials of the textured mesh.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for segmenting regions of virtual materials as described herein.

FIG. 2 depicts a system in an example implementation showing operation of a material segmentation module for segmenting regions of virtual materials.

FIG. 3 depicts an example of receiving an input including a textured mesh and markers indicating one or more regions of the textured mesh corresponding to a material type.

FIG. 4 depicts an example of identifying an additional region of the textured mesh corresponding to the material type.

FIG. 5 depicts an example of segmenting pixels using an algorithm.

FIG. 6 depicts an example of generating a material map.

FIG. 7 depicts a procedure in an example implementation of segmenting regions of virtual materials.

FIG. 8 depicts a procedure in an additional example implementation of segmenting regions of virtual materials.

FIG. 9 depicts a procedure in an additional example implementation of segmenting regions of virtual materials.

FIG. 10 illustrates an example system including various components of an example device that can be implemented as any type of computing device as described and/or utilized with reference to FIGS. 1-9 to implement embodiments of the techniques described herein.

### DETAILED DESCRIPTION

### Overview

Textured meshes are used to represent objects in a virtual, three-dimensional space. A textured mesh, for instance, is composed of vertices, edges, and faces that represent surfaces of an object. The surfaces of the textured mesh convey virtual materials using varying normal properties and colors that mimic texture. Because the textured meshes are frequently applied in virtual environments, including video games, advertising, and animation, a need exists to edit the virtual materials represented on the textured meshes to create realistic-looking objects in the virtual, three-dimensional space. Editing the virtual materials involves generating a material map of the textured mesh, which identifies the virtual materials represented on the textured meshes to facilitate selection and editing of the virtual materials.

Conventional material map generation techniques sort pixels into material categories based on visual appearance. Although these conventional material map generation techniques are useful to generate material maps based on flat surfaces of textured meshes that have few curves, edges, or other three-dimensional features, the conventional material map generation techniques struggle to generate material maps that accurately identify virtual materials on textured meshes with multiple or complex three-dimensional features, including curves or edges. This is because the conventional material map generation techniques do not consider three-dimensional positions or normal properties of the textured meshes when sorting pixels, resulting in material maps that incorrectly identify the virtual materials represented on the textured mesh. This limits the ability to accurately edit the textured meshes, producing results that are not aesthetically pleasing.

Techniques and systems are described for segmenting regions of virtual materials that overcome these limitations. A material segmentation system begins in this example by receiving an input including a textured mesh and markers identifying regions of the textured mesh corresponding to material types. For instance, the markers are scribbles drawn over the regions of the textured mesh in a user interface.

In an example, the textured mesh is a virtual 3D representation of a birthday present. Surfaces of the textured mesh represent multiple materials, including wrapping paper, silk ribbon, and a foil bow of the birthday present. The material segmentation system receives markers corresponding to specific material types on the textured mesh. A red scribble, for instance, is drawn on a region of the wrapping paper, a yellow scribble is drawn on a region of the silk ribbon, and a blue scribble is drawn on a region of the foil bow. However, markers are not received for every region of the birthday present, making the material types for some regions of the textured mesh unknown.

To generate a complete material map of the textured mesh, the material segmentation system identifies additional regions of the textured mesh corresponding to the multiple material types. To do this, the material segmentation system leverages an algorithm that compares three-dimensional positions, color values, and normal properties of pixels of the textured mesh. The three-dimensional positions indicate locations of the pixels in the three-dimensional space, the color values indicate colors of the pixels, and the normal properties indicate surface information designating texture depicted by groups of pixels. Because pixels depicting a specific material type have similar three-dimensional positions, color values, and normal properties, the algorithm identifies groups of pixels of the textured mesh that correspond to the additional region corresponding to the material type. For example, the material segmentation system identifies additional regions of the birthday present that correspond to the wrapping paper, the silk ribbon, and the foil bow that were not identified by the markers.

To generate the material map, the material segmentation system then categorizes pixels of the textured mesh by grouping the pixels corresponding to the region of the textured mesh with the pixels corresponding to the additional region of the textured mesh. Because the pixels corresponding to the region of the textured mesh and the pixels corresponding to the additional region of the textured mesh represent a single material type, accurately determined by the algorithm that compares the three-dimensional positions, the color values, and the normal properties of pixels of the textured mesh, the map generation system segments the material type from other material types represented on the textured mesh. Therefore, the material map organizes the virtual materials of the textured mesh by material type to allow an individual virtual material of the textured mesh to be edited. In other examples, the material map allows an individual virtual material to be selected for incorporation into another textured mesh or other application. Additionally or alternatively, the material map allows for accurate categorization of different virtual materials represented in a virtual environment.

In the given example, the material segmentation system generates a material map of the birthday present that identifies the regions that correspond to the wrapping paper, the silk ribbon, and the foil bow. Because the material map segments the material types, it is possible to individually edit a texture or other feature of the material types, for example, switching out the foil bow for a silk bow, with a higher degree of accuracy than the conventional material map generation techniques. For instance, the conventional material map generation techniques struggle to generate a material map that accurately identifies the virtual material of the foil bow because of its curves and complex geometry. In contrast, the material segmentation system accurately generates a material map of the birthday present, including the foil bow, by identifying the additional regions of the textured mesh corresponding to the material types of the birthday present by comparing the three-dimensional positions, color values, and normal properties of the pixels.

Segmenting regions of virtual materials in this manner overcomes the disadvantages of conventional material map generation techniques that are limited to generating material maps for flat surfaces. For example, receiving the markers as input provides the algorithm with a starting point for accurately segmenting material types of the textured mesh. Additionally, the algorithm identifies additional regions of the textured mesh corresponding to the material types by comparing the three-dimensional positions, color values, and normal properties of pixels. This factors three-dimensional geometry and texture into the algorithm, unlike the conventional material map generation techniques, which operate on flat surfaces of and merely sort pixels into material categories based on visual appearance. For these reasons, segmenting regions of virtual materials produces material maps with greater accuracy than conventional material map generation techniques, thereby increasing ease of editing the virtual materials of the textured mesh and producing aesthetically pleasing results.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

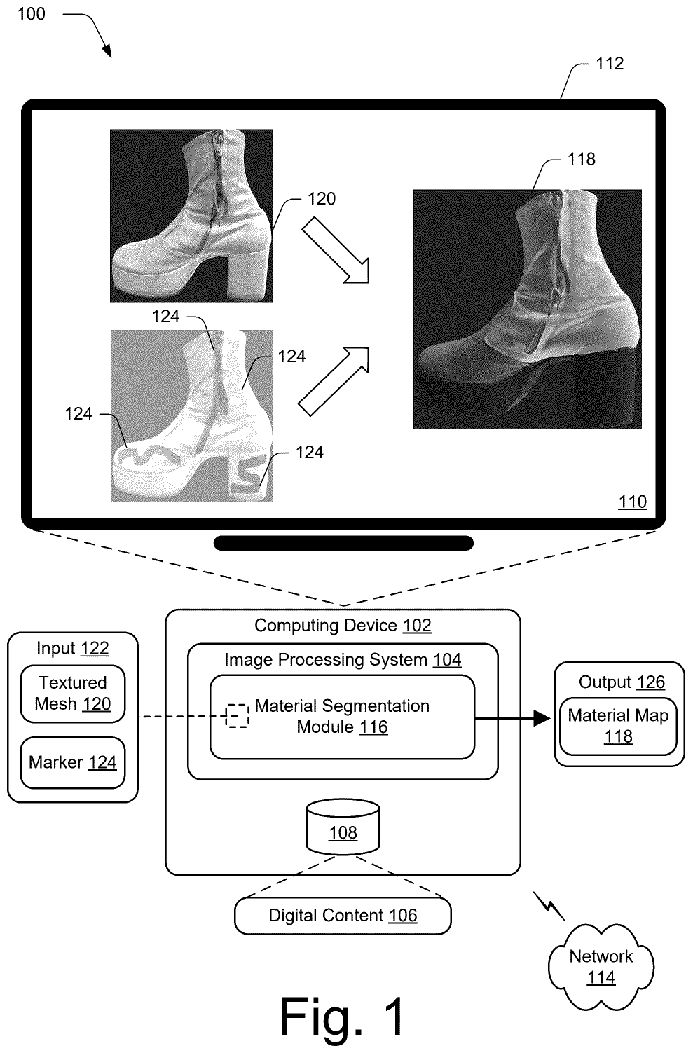

FIG. 1 is an illustration of a digital medium environment 100 in an example implementation that is operable to employ techniques and systems for segmenting regions of virtual materials described herein. The illustrated digital medium environment 100 includes a computing device 102, which is configurable in a variety of ways.

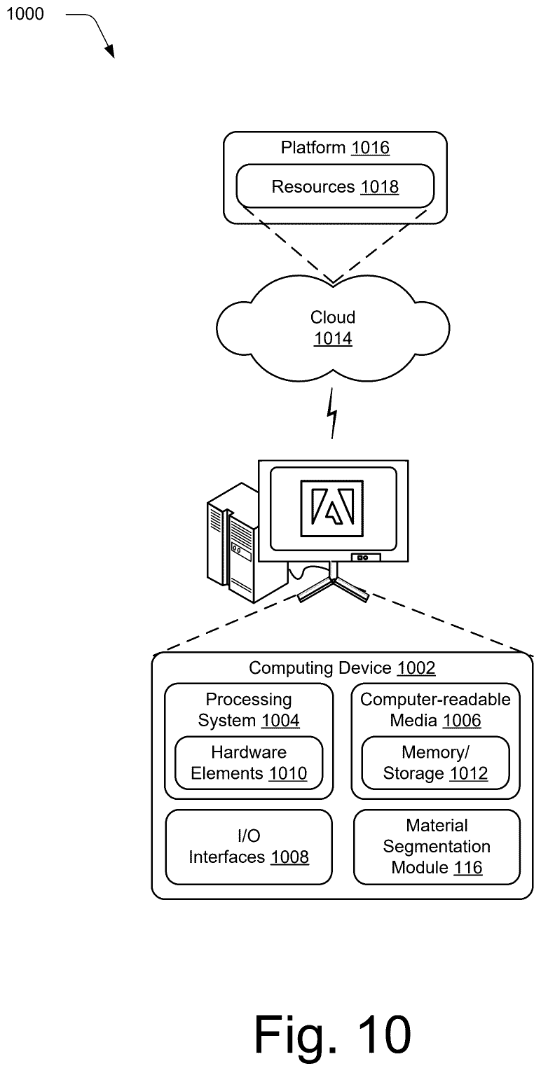

The computing device 102, for instance, is configurable as a desktop computer, a laptop computer, a mobile device (e.g., assuming a handheld configuration such as a tablet or mobile phone), an augmented reality device, and so forth. Thus, the computing device 102 ranges from full resource devices with substantial memory and processor resources (e.g., personal computers, game consoles) to a low-resource device with limited memory and/or processing resources, e.g., mobile devices. Additionally, although a single computing device 102 is shown, the computing device 102 is also representative of a plurality of different devices, such as multiple servers utilized by a business to perform operations “over the cloud” as described in FIG. 10.

The computing device 102 also includes an image processing system 104. The image processing system 104 is implemented at least partially in hardware of the computing device 102 to process and represent digital content 106, which is illustrated as maintained in storage 108 of the computing device 102. Such processing includes creation of the digital content 106, representation of the digital content 106, modification of the digital content 106, and rendering of the digital content 106 for display in a user interface 110 for output, e.g., by a display device 112. Although illustrated as implemented locally at the computing device 102, functionality of the image processing system 104 is also configurable entirely or partially via functionality available via the network 114, such as part of a web service or “in the cloud.”

The computing device 102 also includes a material segmentation module 116 which is illustrated as incorporated by the image processing system 104 to process the digital content 106. In some examples, the material segmentation module 116 is separate from the image processing system 104 such as in an example in which the material segmentation module 116 is available via the network 114.

The material segmentation module 116 is configured to generate a material map 118 that identifies different virtual materials represented in a textured mesh 120. The textured mesh 120 is a virtual representation of an object in a three-dimensional environment, and is composed of a collection of vertices, edges, and faces. For instance, polygons form a surface of the object, which is rendered in a variety of three-dimensional environments.

Because the textured mesh 120 mimics an object in the real world, the textured mesh 120 includes multiple different textures on different surfaces of the textured mesh 120 that represent multiple virtual materials. In this example, the textured mesh 120 is a white leather boot, which is rendered in a three-dimensional environment. Different surfaces of the boot have different textures that represent different virtual materials, including plastic for a heel of the boot, leather for a toe of the boot, and metal for a zipper of the boot.

To allow for editing of the multiple virtual materials of the textured mesh 120 on an individual basis, the material segmentation module 116 generates the material map 118, which identifies the multiple virtual materials present on the textured mesh 120. For instance, the material map 118 segments pixels of the textured mesh 120 into categories according to virtual material. The virtual materials of the textured mesh 120 correspond to an ID and are capable of being individually edited. For instance, the material map 118 allows the leather regions of the boot to be switched out with suede.

To generate the material map 118, the material segmentation module 116 receives an input 122 including the textured mesh 120 and at least one marker 124 identifying a region of the textured mesh 120 corresponding to a material type. In some examples, the marker 124 is a squiggle or line indicating the region, which is drawn over the textured mesh 120 in the user interface 110. In this example, the marker 124 is drawn in green over the zipper of the boot, pink over the toe of the boot, blue over the heel of the boot, and yellow over the back of the boot, which represent the multiple different virtual materials of the boot.

The material segmentation module 116 then uses a k-nearest neighbors matting algorithm that considers three-dimensional features of the textured mesh or other algorithm to identify additional regions of the textured mesh 120 corresponding to the different virtual materials of the boot. For instance, the material segmentation module 116 uses the algorithm to identify that a front region of the boot, which did not have marker identifying its virtual material, corresponds to the virtual material represented on the back of the boot. Because the front of the boot and the back of the boot are both leather, the material segmentation module 116 groups the pixels of these regions together and segments the leather regions of the boot from pixels of the boot corresponding to other virtual materials.

To do this, the algorithm compares three-dimensional positions, color values, and normal properties of the pixels of the textured mesh 120. The three-dimensional positions describe positions of pixels in a three-dimensional environment, and the normal properties relate to a type of texture displayed by groups of pixels. Because regions corresponding to a virtual material have similar pixels, comparing the three-dimensional positions, the color values, and the normal properties allows the material segmentation module 116 to accurately segment the textured mesh 120 into the multiple virtual materials.

After segmenting the regions corresponding to different virtual materials, the material segmentation module 116 assigns labels to the regions identifying the different virtual materials, which allows for separate editing of the different virtual materials in some examples. The material segmentation module 116 then generates an output 126 including the material map 118 for display in the user interface 110, further examples of which are described in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Segmenting Regions of Virtual Materials

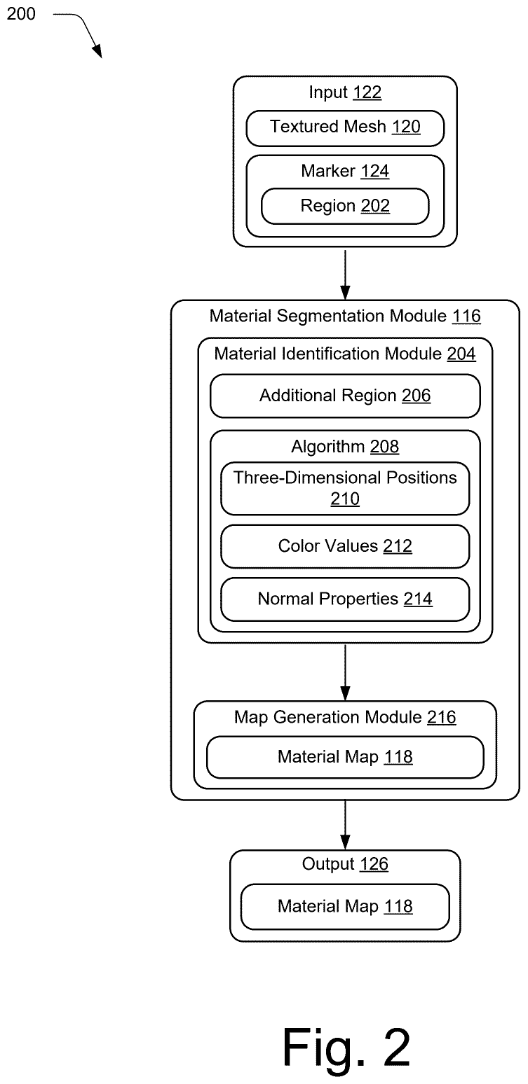

FIG. 2 depicts a system 200 in an example implementation showing operation of the material segmentation module 116 of FIG. 1 in greater detail. The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-10.

To begin in this example, a material segmentation module 116 receives an input 122 including a textured mesh 120 and a marker 124. The textured mesh 120 is a virtual representation of a three-dimensional object with multiple surfaces. Multiple virtual materials are represented on different surfaces of the textured mesh 120. Examples of the multiple virtual materials include stone, brick, wood, plastic, fabric, silk, leather, rubber, metal, or any other type of material. The marker 124 indicates a region 202 of the textured mesh 120 corresponding to a material type. For instance, the marker 124 is a scribble drawn in a user interface 110 indicating a region of the textured mesh 120 that corresponds to a material type. In some examples, multiple markers in a single color are received that indicate multiple regions of the textured mesh 120 that correspond to the material type.

The material segmentation module 116 includes a material identification module 204. For instance, so identify a complete collection of regions of the textured mesh 120 that correspond to the specific material indicted by the marker 124, the material identification module 204 identifies an additional region 206 of the textured mesh 120 corresponding to the material type. To do this, the material identification module 204 leverages an algorithm 208, an example of which is a k-nearest neighbors matting algorithm that considers three-dimensional features of the textured mesh 120. The algorithm 208 compares three-dimensional positions 210, color values 212, and normal properties 214 of pixels of the textured mesh 120 to identify the additional region 206 of the textured mesh 120. The three-dimensional positions 210 indicate locations of the pixels in a three-dimensional space. The color values 212 indicate colors of the pixels. The normal properties 214 indicate surface information designating texture depicted by groups of pixels. Pixels depicting a specific material type have similar three-dimensional positions 210, color values 212, and normal properties 214. Therefore, the algorithm 208 identifies groups of pixels of the textured mesh 120 that correspond to the additional region 206 corresponding to the material type.

The material segmentation module 116 also includes a map generation module 216 that categorizes pixels of the region 202 together with pixels of the additional region 206 to form the material map 118. For instance, after the material identification module 204 identifies the additional region 206 of the textured mesh 120 corresponding to the material type, the map generation module 216 groups the pixels corresponding to the region 202 of the textured mesh 120 with the pixels corresponding to the additional region 206 of the textured mesh 120. Because the pixels corresponding to the region 202 of the textured mesh 120 and the pixels corresponding to the additional region 206 of the textured mesh 120 represents the material type, the map generation module 216 segments the material type from other material types represented on the textured mesh 120.

The material segmentation module 116 then generates an output 126 including the material map 118 for display in a user interface 110. The material map 118 identifies the material type, which is segmented from the other material types represented on the textured mesh 120. In some examples, the material map 118 includes texture IDs, which are labels identifying the material types of the material map 118. For instance, a texture ID allows for individual editing of the material types.

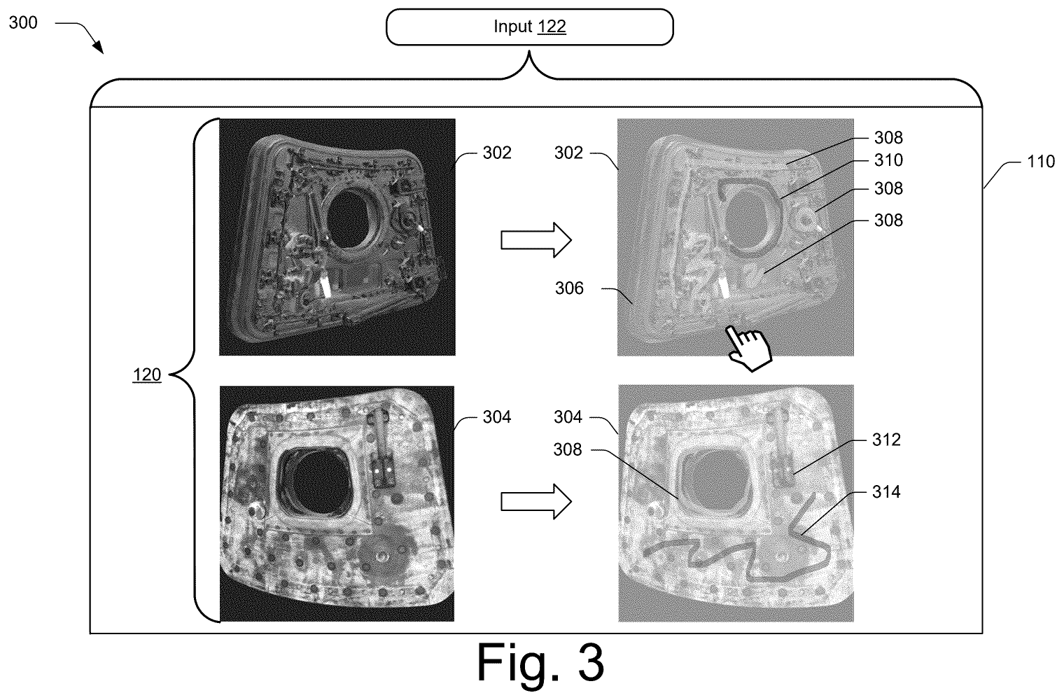

FIGS. 3-6 depict stages of segmenting regions of virtual materials. In some examples, the stages depicted in these figures are performed in a different order than described below.

FIG. 3 depicts an example 300 of receiving an input including a textured mesh and markers indicating one or more regions of the textured mesh corresponding to a material type. To begin, the material segmentation module 116 receives an input including a textured mesh 120. The textured mesh 120 includes per-pixel color values and information related to three-dimensional features of the textured mesh 120. As illustrated, in this example the textured mesh 120 is a virtual three-dimensional representation of a submarine door for a video game. The textured mesh 120 includes a front view texture mesh 302 and a rear view texture mesh 304, both of which depict multiple virtual materials, including smooth metal, rough metal, shiny metal, and rusty metal, which produce realistic effects when viewed together in a three-dimensional environment. However, in this example it is desired to edit a texture or other features of the multiple virtual materials.

To identify the multiple virtual materials represented on the textured mesh 120, the material segmentation module 116 also receives multiple markers, which are drawn as squiggles identifying regions of the textured mesh 120 corresponding to material types. Specifically, the material segmentation module 116 a green marker 306 indicating a region of a smooth metal material, yellow markers 308 indicating a regions of a rough metal material, a blue marker 310 indicating a region of a rubber material, a pink marker 312 indicating a region of a shiny metal material, and a red marker 314 indicating a region of a rusty metal material.

In this example, the markers do not cover every surface of the textured mesh 120. For instance, the material segmentation module 116 receives one or multiple markers identifying a region of the textured mesh 120 corresponding to a material type. In some examples, the markers are input using a variety of methods including drawn as a touch input in the user interface 110 or using a cursor of the computing device 102. Additionally, in some examples, the material segmentation module 116 also receives labels indicating names or other identifying information labeling the material types. For example, the material segmentation module 116 receives a label “rusty metal” corresponding to the red marker 314.

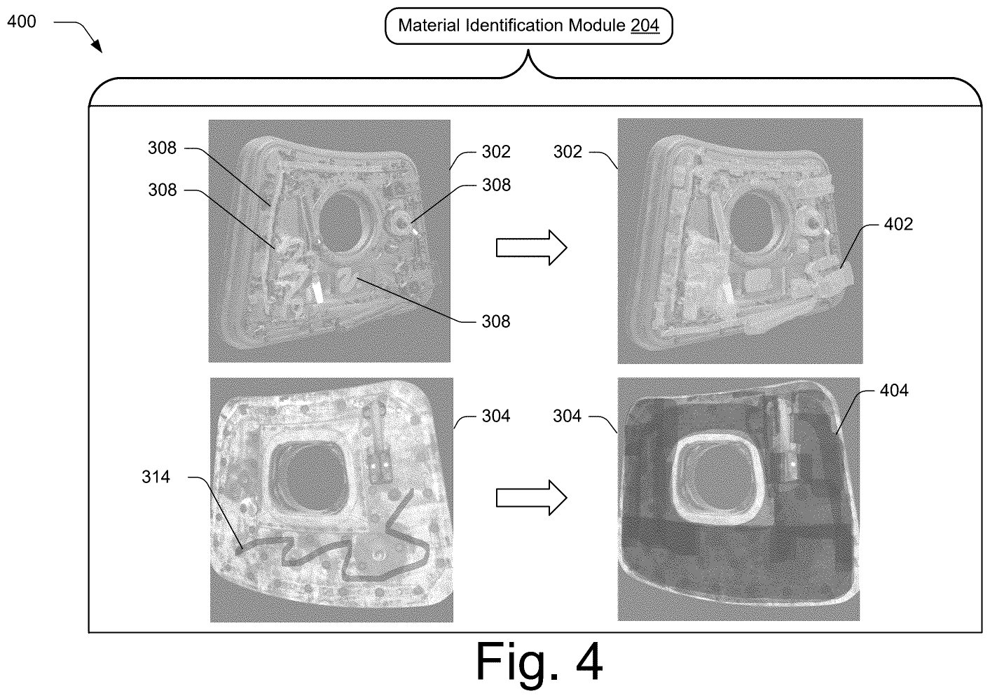

FIG. 4 depicts an example 400 of identifying an additional region of the textured mesh corresponding to the material type. FIG. 4 is a continuation of the example 300 described with respect to FIG. 3. After the material segmentation module 116 receives the textured mesh 120 and the markers, including the green marker 306, the yellow markers 308, the blue marker 310, the pink marker 312, and the red marker 314 corresponding to the material types of the textured mesh 120, the material identification module 204 identifies additional regions of the textured mesh 120 corresponding to the material types.

For illustration purposes, the front view texture mesh 302 in this example depicts the yellow markers 308, and the rear view texture mesh 304 depicts the red marker 314. In other examples, the textured mesh 120 or sections of the textured mesh 120 include multiple markers. For instance, the yellow markers 308 indicate the regions of the rough metal material, and the red marker 314 indicates the region of the rusty metal material of the door. The regions of the textured mesh 120 corresponding to the material types are incomplete because the material segmentation module 116 does not receive input identifying some regions of the textured mesh 120 corresponding to the material types in this example. To identify a more complete collection of regions corresponding to the material types of the textured mesh 120, the material segmentation module 116 includes a material identification module 204.

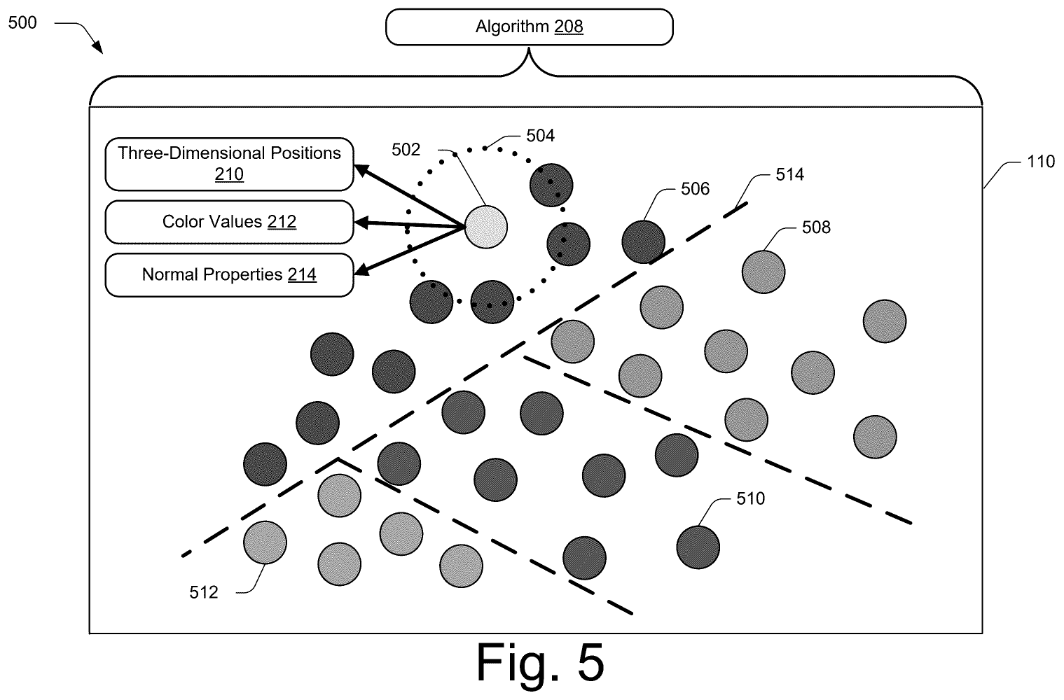

The material identification module 204 identifies an additional region 206 or additional regions of the textured mesh 120 corresponding to the material types using an algorithm 208. An example of the algorithm 208 is a k-nearest neighbors matting algorithm, which is discussed in further detail with respect to FIG. 5. For example, the algorithm 208 identifies the additional regions of the textured mesh 120 by comparing three-dimensional positions 210, color values 212, and normal properties 214 of pixels of the textured mesh 120 to pixels of the regions of the textured mesh 120 corresponding to the material types. The three-dimensional positions 210 indicate locations of the pixels in a three-dimensional space. The color values 212 indicate colors of the pixels. The normal properties 214 indicate surface information designating texture depicted by groups of pixels. Pixels depicting a specific material type have three-dimensional positions 210, color values 212, and normal properties 214 that are similar. Although this example involves the three-dimensional positions 210, the color values 212, and the normal properties 214, in some examples the algorithm 208 identifies the additional regions of the textured mesh 120 using different properties of pixels.

Therefore, the algorithm 208 identifies groups of pixels of the textured mesh 120 that correspond to the material types of the regions of the textured mesh 120 identified by the markers. For instance, the algorithm 208 identifies individual pixels or groups of pixels that have the three-dimensional positions 210, the color values 212, and the normal properties 214 of the material types of the regions of the textured mesh 120 identified by the markers.

As illustrated in this example, the material identification module 204 identifies an additional region 402 of the front view texture mesh 302 that corresponds to the material type identified by the yellow markers 308. For instance, the additional region 402 corresponds to the rough metal material of the door identified by the yellow markers 308. To do this, the material identification module 204 uses the algorithm 208 to compare pixels or groups of pixels of the front view texture mesh 302 that are adjacent to the yellow markers 308 based on the three-dimensional positions 210, the color values 212, and the normal properties 214 of the pixels. For instance, the pixels of the additional region 402 have the three-dimensional positions 210, the color values 212, and the normal properties 214 of the pixels of the regions identified by the yellow markers 308, which correspond to pixels representing the rough metal material of the door. For instance, while comparing the pixels of the front view texture mesh 302, the algorithm 208 in this example determines that the pixels of the regions of the textured mesh 120 identified by the yellow markers 308 have three-dimensional positions 210 around protrusions of the door, color values 212 that are dark on a color scale, and normal properties 214 that are high and indicate a rough texture. In some examples, the algorithm 208 determines a threshold level or applies a pre-determined threshold level to compare the pixels of the textured mesh 120. Therefore, the algorithm 208 identifies the additional region 402 that have similar properties visually to the properties of the region identified by the yellow markers 308.

The material identification module 204 also identifies an additional region 404 of the rear view texture mesh 304 that corresponds to the material type identified by the red marker 314. For instance, the additional region 404 corresponds to the rusty metal material of the door identified by the red marker 314. To do this, the material identification module 204 uses the algorithm 208 to compare pixels or groups of pixels of the rear view texture mesh 304 that are adjacent to the red marker 314 based on the three-dimensional positions 210, the color values 212, and the normal properties 214 of the pixels. For instance, the pixels of the additional region 404 have the three-dimensional positions 210, the color values 212, and the normal properties 214 of the pixels of the regions identified by the red marker 314, which correspond to pixels representing the rusty metal material of the door. For instance, while comparing the pixels of the rear view texture mesh 304, the algorithm 208 in this example determines that the pixels of the regions of the textured mesh 120 identified by the red marker 314 have three-dimensional positions 210 on flat surfaces of the door, color values 212 that are red on a color scale, and normal properties 214 that are medium and indicate a medium-rough texture. Therefore, the algorithm 208 identifies the additional region 402 that have similar properties visually to the properties of the region identified by the yellow markers 308.

In some examples, the material identification module 204 also completes or fills in the region 202 of the textured mesh 120 corresponding to the material type. For instance, in an example including a marker 124 that is an incomplete scribble that identifies a portion of the region 202, the region 202 uses the algorithm 208 to analyze pixels surrounding or nearby pixels indicated by the marker 124 to generate a region 202 or an additional region 206 that is more complete. In this example, the yellow markers 308 and the red marker 314 are scribbles that do not cover an entirety of the regions of the textured mesh 120. While identifying the additional regions of the textured mesh 120, for instance, the algorithm 208 also identifies pixels with properties corresponding to the pixels directly underneath the yellow markers 308 and the red marker 314. For example, the pixels with the properties corresponding to the pixels based on the three-dimensional positions 210, the color values 212, and the normal properties 214.

FIG. 5 depicts an example 500 of segmenting pixels using an algorithm. FIG. 5 shows additional detail related to the algorithm 208 described in example 400 with respect to FIG. 4.

In this example, the algorithm 208 is a k-nearest neighbors matting algorithm that identifies pixels of the additional region 206 of the textured mesh 120 that have the three-dimensional positions 210, the color values 212, and the normal properties 214 of the pixels of the region 202 of the textured mesh 120. The three-dimensional positions 210 indicate locations of the pixels in a three-dimensional space. The color values 212 indicate colors of the pixels. The normal properties 214 indicate surface information designating texture depicted by groups of pixels. Pixels depicting a specific material type have three-dimensional positions 210, color values 212, and normal properties 214 that are similar. Although this example involves the three-dimensional positions 210, the color values 212, and the normal properties 214, in some examples the algorithm 208 identifies the additional regions of the textured mesh 120 using different properties of pixels.

The k-nearest neighbors matting algorithm, in some examples, is a type of machine learning algorithm that is capable of classifying pixels or other points that compose meshes. The k-nearest neighbors matting algorithm operates by comparing adjacent data points, including pixels. Although in this example the k-nearest neighbors matting algorithm operates using the marker 124 as input and is not trained, in some examples the k-nearest neighbors matting algorithm is trained on a stored dataset.

To make a prediction related to which pixels of the textured mesh 120 have similar properties, the k-nearest neighbors matting algorithm calculates a distance to other pixels of the textured mesh 120 from a test pixel, which is selected randomly in some examples. The k-nearest neighbors matting algorithm then selects k closest pixels (i.e. “neighbors”) to the test pixel, which is determined in some examples by a threshold distance. The k-nearest neighbors matting algorithm then uses majority voting among the neighbors to determine properties or a class of the test pixel. The majority voting is based on known properties of the k-nearest neighbors matting. For instance, a pixel with unknown properties located adjacent to a pixel with known properties is more likely to have the known properties of the pixel than other properties of pixels located further from the pixel with the unknown properties. For example, the k-nearest neighbors matting algorithm determines the three-dimensional positions 210, the color values 212, and the normal properties 214 for the text pixel. The k-nearest neighbors matting algorithm repeats this for other pixels of the textured mesh 120.

In some examples, the material segmentation module 116 also receives relative importances related to the three-dimensional positions 210, the color values 212, and/or the normal properties 214. For instance, the relative importances are based on a scale (e.g., 1-100) or an ordered list (e.g., the normal properties 214 has a higher importance than the three-dimensional positions 210). In some examples, the relative importances are based on a user input or are determined by a machine learning model trained to determine the relative importances related to the three-dimensional positions 210, the color values 212, and the normal properties 214 related to a particular task. In response to receiving the relative importances, the algorithm 208 adjusts the majority voting to determine the properties of the pixels. In an example, a pixel otherwise classified as one material type is now classified as a different material type based on the relative importances.

In this example, the test pixel 502 is a pixel of the textured mesh 120 that is not identified as a region corresponding to the material type. For instance, the test pixel 502 is an “unknown” pixel that is not identified by a marker 124. However, the k-nearest neighbors matting algorithm determines the three-dimensional positions 210, the color values 212, and the normal properties 214 based on the three-dimensional positions 210, the color values 212, and the normal properties 214 of the nearest neighbor pixels 504, which are four pixels corresponding to region identified by the red marker 314 in this example, meaning they correspond to the rusty metal texture. Therefore, the k-nearest neighbors matting algorithm determines that the test pixel 502 has the three-dimensional positions 210, the color values 212, and the normal properties 214 of the region corresponding to the rusty metal texture.

After repeating this for other unknown pixels of the textured mesh 120, the k-nearest neighbors matting algorithm identifies which of the multiple virtual materials correspond to the pixels of the textured mesh 120. The material identification module 204 then identifies additional regions of the textured mesh 120 that correspond to different materials of the textured mesh 120 based on the identified pixels. In this example, the textured mesh 120 identifies an additional region corresponding to the rusty metal material 506 of the door, an additional region corresponding to the smooth metal material 507 of the door, an additional region corresponding to the rubber material 510 of the door, and an additional region corresponding to the shiny metal material 512 of the door. In some examples, the material identification module 204 also determines a boundary 514 between material types of the textured mesh 120.

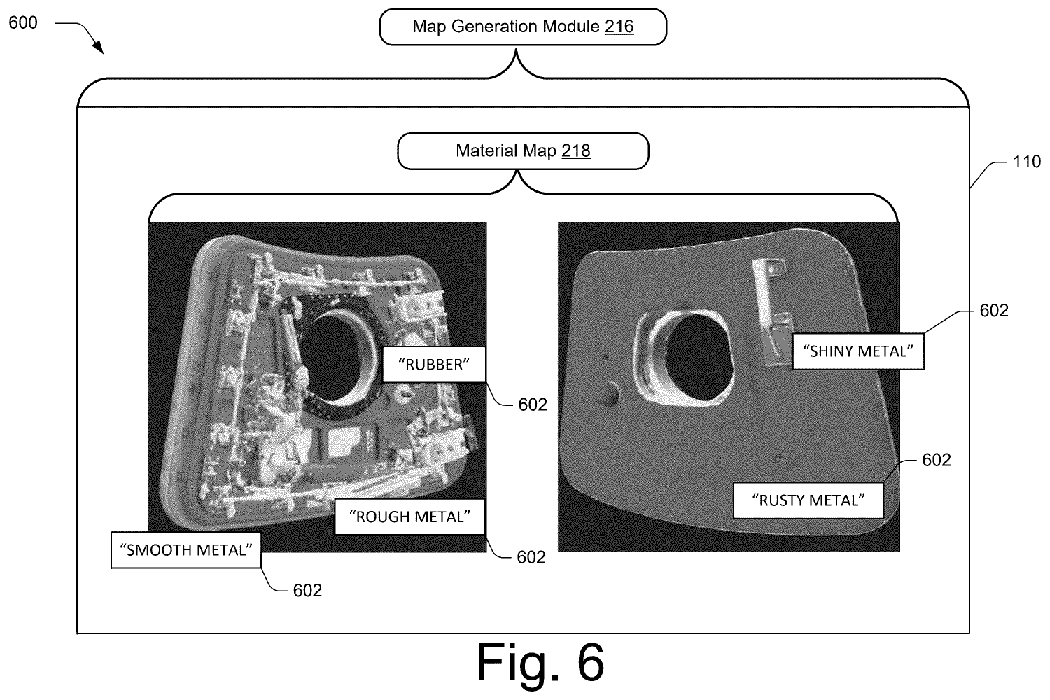

FIG. 6 depicts an example 600 of generating a material map. FIG. 6 is a continuation of the example 400 described with respect to FIG. 4. After the material identification module 204 identifies the additional regions of the textured mesh 120 corresponding to the material types, the map generation module 216 generates a material map 118 that segments the material types of the textured mesh 120.

For illustration purposes, the material map 118 is shown as a front view and a rear view. The map generation module 216 generates the material map 118 by categorizing the regions of the textured mesh 120 corresponding the material types and the additional regions of the textured mesh 120 corresponding the material types. For instance, the map generation module 216 groups regions corresponding to the same material type together to enhance convenience of editing the material types.

In this example, the map generation module 216 groups the region corresponding to the rusty metal material of the door with the additional region corresponding to the rusty metal material of the door. The map generation module 216 groups the region corresponding to the smooth metal material of the door with the additional region corresponding to the smooth metal material of the door. The map generation module 216 groups the region corresponding to the rough metal material of the door with the additional region corresponding to the rough metal material of the door. The map generation module 216 groups the region corresponding to the rubber material of the door with the additional region corresponding to the rubber material of the door. The map generation module 216 groups the region corresponding to the shiny metal material of the door with the additional region corresponding to the shiny metal material of the door. In some examples, the map generation module 216 also assigns a texture ID 602 to a region of the material map 118 corresponding to a material type. In this example, the map generation module 216 assigns a texture ID 602 to each of the material types of the material map 118, including “Rusty Metal,” “Smooth Metal,” “Rough Metal,”, “Rubber,” and “Shiny Metal.” This allows a user to select a material type of the material map 118 based on the texture ID 602.

To visually designate different material types of the multiple virtual materials, in some examples the map generation module 216 also applies different colors to different material types on the material map 118. In this example, the map generation module 216 assigns red to the rusty metal material, green to the smooth metal material, yellow to rough metal material, blue to the rubber material, and pink to the shiny metal material, based on the colors of the red marker 314, the green marker 306, the yellow markers 308, the blue marker 310, and the pink marker 312, received from the input 122. This clearly distinguishes the regions of the textured mesh 120 that correspond to the material types, for ease of editing.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-6.

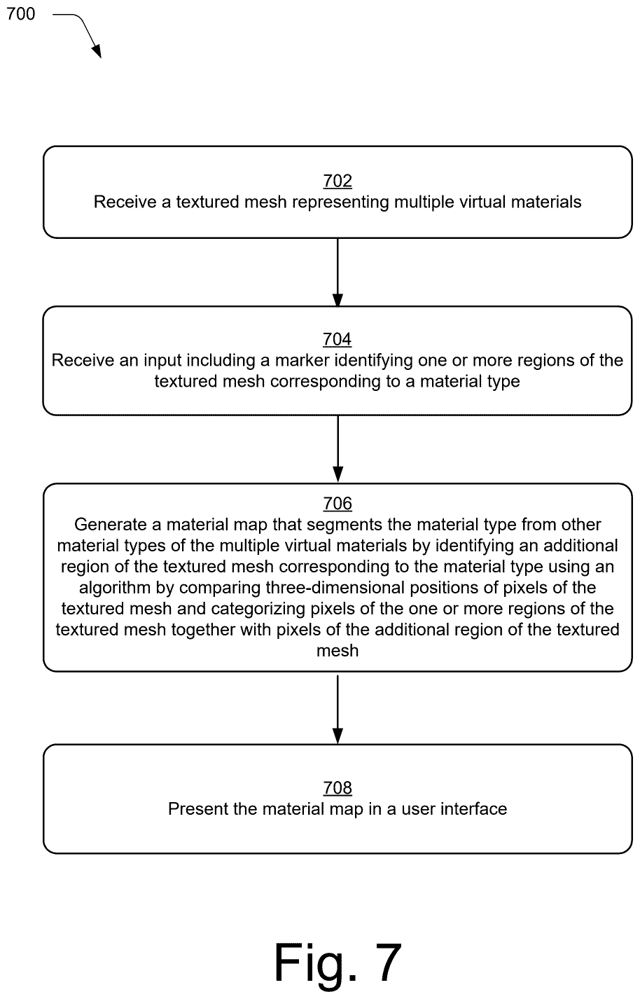

FIG. 7 depicts a procedure 700 in an example implementation of segmenting regions of virtual materials. At block 702, a textured mesh 120 representing multiple virtual materials is received. For example, the textured mesh 120 is a virtual representation of an object in a three-dimensional environment, featuring the multiple virtual materials on surfaces of the textured mesh 120.

At block 704, an input including a marker 124 identifying one or more regions of the textured mesh 120 corresponding to a material type is received. In some examples, the marker 124 is a scribble drawn over the textured mesh in the user interface 110.

At block 706, a material map 118 is generated that segments the material type from other material types of the multiple virtual materials by identifying an additional region 206 of the textured mesh 120 corresponding to the material type using an algorithm 208 by comparing three-dimensional positions 210 of pixels of the textured mesh and categorizing pixels of the one or more regions of the textured mesh 120 together with pixels of the additional region 206 of the textured mesh 120. Some examples further comprise identifying the additional region 206 of the textured mesh 120 by comparing color values 212 and normal properties 214 of the pixels of the textured mesh 120 using the algorithm 208. Additionally, some examples further comprise receiving an additional input to change a relative importance of the three-dimensional positions 210, the color values 212, and the normal properties 214 of the pixels of the textured mesh 120 and updating the algorithm 208 based on the additional input. For example, the algorithm 208 is a k-nearest neighbors matting algorithm that considers three-dimensional features of the textured mesh 120.

At block 708, the material map 118 is presented in a user interface 110. In some examples, the material map 118 includes texture IDs corresponding to the multiple virtual materials of the textured mesh 120. In some examples, the material map 118 visually designates different material types of the multiple virtual materials. Additionally or alternatively, the different material types are identified by different colors on the material map 118. Some examples further comprise identifying boundaries of the different material types using a k-nearest neighbors matting algorithm and depicting the boundaries on the material map 118.

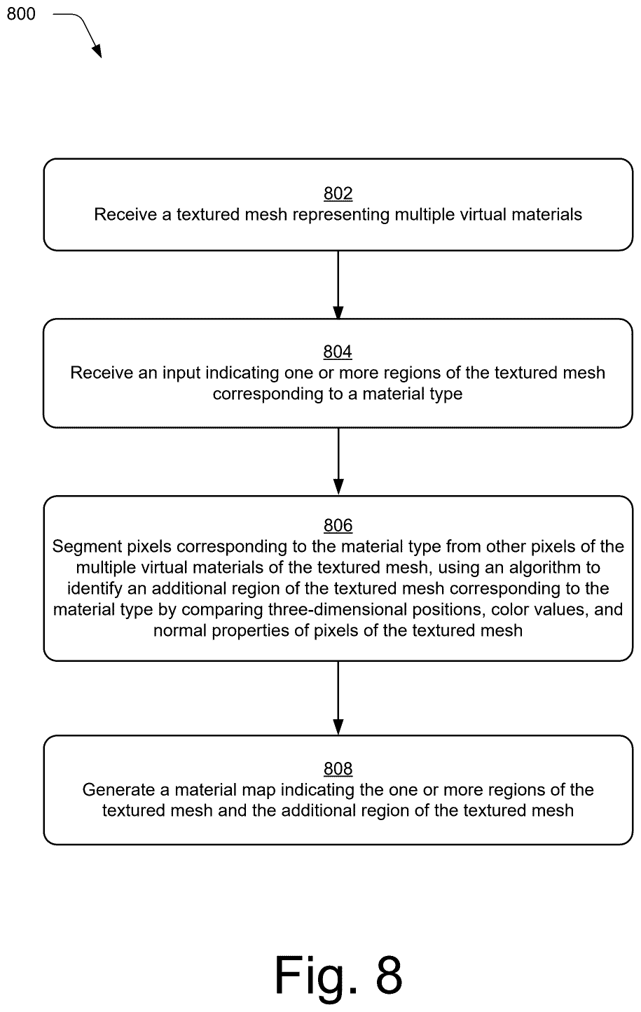

FIG. 8 depicts a procedure 800 in an additional example implementation of segmenting regions of virtual materials. At block 802, a textured mesh 120 representing multiple virtual materials is received.

At block 804, an input indicating one or more regions of the textured mesh corresponding to a material type is received. In some examples, the input is a scribble drawn over the textured mesh 120 in a user interface 110.

At block 806, pixels are segmented corresponding to the material type from other pixels of the multiple virtual materials of the textured mesh 120, using an algorithm 208 to identify an additional region 206 of the textured mesh 120 corresponding to the material type by comparing three-dimensional positions 210, color values 212, and normal properties 214 of pixels of the textured mesh 120. Some examples further comprise receiving an additional input to change a relative importance of the three-dimensional positions 210, the color values 212, and the normal properties 214 of the pixels of the textured mesh 120 and updating the algorithm 208 based on the additional input. In some examples, the algorithm 208 is a k-nearest neighbors matting algorithm that considers three-dimensional features of the textured mesh 120.

At block 808, a material map 118 is generated indicating the one or more regions of the textured mesh 120 and the additional region 206 of the textured mesh 120. In some examples, the material map 118 includes texture IDs corresponding to the multiple virtual materials of the textured mesh 120. For example, the material map 118 visually designates different material types of the multiple virtual materials. Some examples further comprise identifying boundaries of the one or more regions of the textured mesh 120 and the additional region 206 of the textured mesh using a k-nearest neighbors matting algorithm and depicting the boundaries on the material map 118.

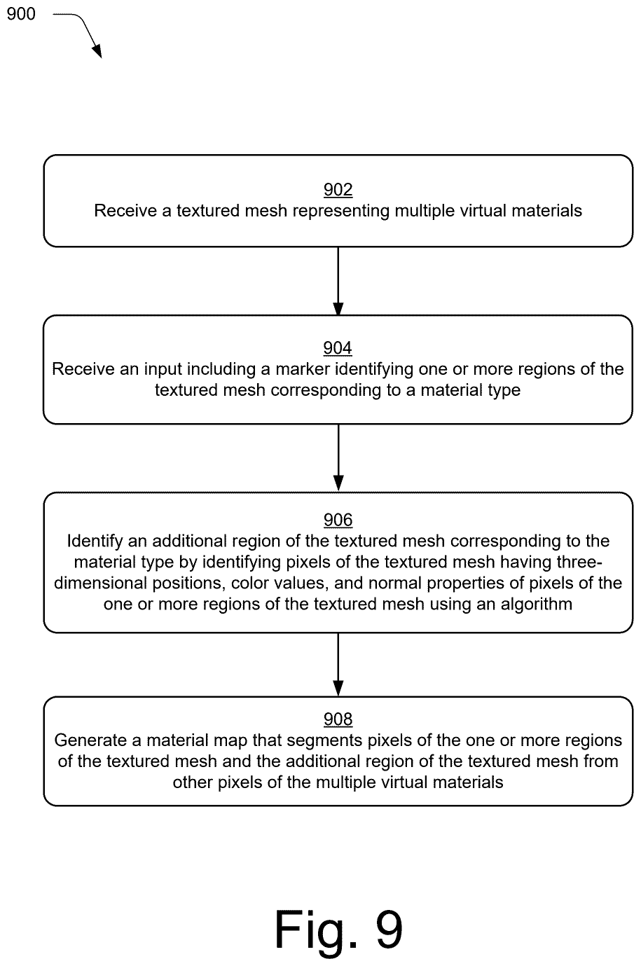

FIG. 9 depicts a procedure 900 in an additional example implementation of segmenting regions of virtual materials. At block 902, a textured mesh 120 representing multiple virtual materials is received.

At block 904, an input including a marker 124 identifying one or more regions of the textured mesh 120 corresponding to a material type is received. For example, the input 122 is a scribble drawn over the textured mesh 120 in a user interface 110.

At block 906, an additional region 206 of the textured mesh 120 corresponding to the material type is identified by identifying pixels of the textured mesh having three-dimensional positions 210, color values 212, and normal properties 214 of pixels of the one or more regions of the textured mesh 120 using an algorithm 208. Some examples further comprise receiving an additional input to change a relative importance of the three-dimensional positions 210, the color values 212, and the normal properties 214 of the pixels of the textured mesh and updating the algorithm 208 based on the additional input.

At block 908, a material map 118 is generated that segments pixels of the one or more regions of the textured mesh 120 and the additional region 206 of the textured mesh 120 from other pixels of the multiple virtual materials. Some examples further comprise identifying boundaries of the one or more regions of the textured mesh 120 and the additional region 206 of the textured mesh 120 using a k-nearest neighbors matting algorithm and depicting the boundaries on the material map 118. For example, the material map 118 includes texture IDs corresponding to the multiple virtual materials of the textured mesh 120.

### Example System and Device

FIG. 10 illustrates an example system generally at 1000 that includes an example computing device 1002 that is representative of one or more computing systems and/or devices that implement the various techniques described herein. This is illustrated through inclusion of the material segmentation module 116. The computing device 1002 is configurable, for example, as a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interface 1008 that are communicatively coupled, one to another. Although not shown, the computing device 1002 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing system 1004. The instructions and/or functions are executable/operable by one or more articles of manufacture (for example, one or more computing devices and/or processing systems 1004) to implement techniques, modules, and examples described herein.

The techniques described herein are supported by various configurations of the computing device 1002 and are not limited to the specific examples of the techniques described herein. This functionality is also implementable through use of a distributed system, such as over a “cloud” 1114 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized when computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

What is claimed is:

1. A method comprising:
receiving, by a processing device, a textured mesh representing multiple virtual materials;
receiving, by the processing device, an input including a marker identifying one or more regions of the textured mesh corresponding to a material type;
generating, by the processing device, a material map that segments the material type from other material types of the multiple virtual materials by:
identifying an additional region of the textured mesh corresponding to the material type using an algorithm by comparing three-dimensional positions of pixels of the textured mesh; and
categorizing pixels of the one or more regions of the textured mesh together with pixels of the additional region of the textured mesh; and presenting, by the processing device, the material map in a user interface.

2. The method of claim 1, further comprising identifying the additional region of the textured mesh by comparing color values and normal properties of the pixels of the textured mesh using the algorithm.

3. The method of claim 2, further comprising receiving an additional input to change a relative importance of the three-dimensional positions, the color values, and the normal properties of the pixels of the textured mesh and updating the algorithm based on the additional input.

4. The method of claim 1, wherein the material map includes texture IDs corresponding to the multiple virtual materials of the textured mesh.

5. The method of claim 1, wherein the algorithm is a k-nearest neighbors matting algorithm that considers three-dimensional features of the textured mesh.

6. The method of claim 1, wherein the marker is a scribble drawn over the textured mesh in the user interface.

7. The method of claim 1, wherein the material map visually designates different material types of the multiple virtual materials.

8. The method of claim 7, wherein the different material types are identified by different colors on the material map.

9. The method of claim 7, further comprising identifying boundaries of the different material types using a k-nearest nearest neighbors matting algorithm and depicting the boundaries on the material map.

10. A system comprising:
a memory component; and
a processing device coupled to the memory component, the processing device to perform operations comprising:
receiving a textured mesh representing multiple virtual materials;
receiving an input indicating one or more regions of the textured mesh corresponding to a material type;
segmenting pixels corresponding to the material type from other pixels of the multiple virtual materials of the textured mesh, using an algorithm to identify an additional region of the textured mesh corresponding to the material type by comparing three-dimensional positions, color values, and normal properties of pixels of the textured mesh; and
generating a material map indicating the one or more regions of the textured mesh and the additional region of the textured mesh.

11. The system of claim 10, the operations further comprising receiving an additional input to change a relative importance of the three-dimensional positions, the color values, and the normal properties of the pixels of the textured mesh and updating the algorithm based on the additional input.

12. The system of claim 10, wherein the material map includes texture IDs corresponding to the multiple virtual materials of the textured mesh.

13. The system of claim 10, wherein the algorithm is a k-nearest neighbors matting algorithm that considers three-dimensional features of the textured mesh.

14. The system of claim 10, wherein the input is a scribble drawn over the textured mesh in a user interface.

15. The system of claim 10, wherein the material map visually designates different material types of the multiple virtual materials.

16. The system of claim 10, the operations further comprising identifying boundaries of the one or more regions of the textured mesh and the additional region of the textured mesh using a k-nearest neighbors matting algorithm and depicting the boundaries on the material map.

17. A non-transitory computer-readable storage medium storing executable instructions, which when executed by a processing device, cause the processing device to perform operations comprising:
receiving a textured mesh representing multiple virtual materials;
receiving an input including a marker identifying one or more regions of the textured mesh corresponding to a material type;
identifying an additional region of the textured mesh corresponding to the material type by identifying pixels of the textured mesh having three-dimensional positions, color values, and normal properties of pixels of the one or more regions of the textured mesh using an algorithm; and
generating a material map that segments pixels of the one or more regions of the textured mesh and the additional region of the textured mesh from other pixels of the multiple virtual materials.

18. The non-transitory computer-readable storage medium of claim 17, the operations further comprising receiving an additional input to change a relative importance of the three-dimensional positions, the color values, and the normal properties of the pixels of the textured mesh and updating the algorithm based on the additional input.

19. The non-transitory computer-readable storage medium of claim 17, wherein the material map includes texture IDs corresponding to the multiple virtual materials of the textured mesh.

20. The non-transitory computer-readable storage medium of claim 17, further comprising identifying boundaries of the one or more regions of the textured mesh and the additional region of the textured mesh using a k-nearest neighbors matting algorithm and depicting the boundaries on the material map.
